(19) United States
(12) Patent Application Publication
(10) Pub. No.: US 2016/0318537 A1
(43) Pub. Date: Nov. 3, 2016

(54) Janitorial Cleaning Cart

(71) Applicant: Curtis Watkins, Garden Grove, CA (US)

(72) Inventor: Curtis Watkins, Garden Grove, CA (US)

(21) Appl. No.: 15/139,064

(22) Filed: Apr. 26, 2016

Related U.S. Application Data
(60) Provisional application No. 62/154,560, filed on Apr. 29, 2015.

(51) Int. Cl. B62B 5/00; B60B 19/08

(52) U.S. Cl. CPC B62B 5/0003; B62B 5/0013; B60B 19/08; B60B 2200/43

(57) ABSTRACT

A janitorial cleaning cart for maximizing garbage and linen collection is provided. The janitorial cleaning cart comprises a cart having a bottom wall, a front wall, a rear wall, a first side wall between the front wall and the rear wall, and a second side wall. The front wall, the rear wall, the first side wall, and the second side wall are connected to and extend in a generally upward direction from the bottom wall. A top opening is formed opposite the bottom wall. An outer perimeter rim surrounds the top opening. A cover lid is restable on the outer perimeter rim for selectively closing the top opening. A front opening is formed in the front wall. At least one door selectively closes the front opening. A plurality of wheels is mounted to the bottom wall. The cart provides an efficient and user friendly means of trash and linen collection.

### CLAIM OF PRIORITY

This patent application claims priority under 35 USC 119 (e) (1) from U.S. Provisional Patent Application Ser. No. 62/154,560 filed Apr. 29, 2015, of common inventorship herewith entitled, “Sanitary Trash and Linen Cart with Quiet Wheels,” which is incorporated herein by reference as though the same were set forth in its entirety.

### FIELD OF THE INVENTION

The present invention pertains to the field of commercial janitorial cleaning cart, and more specifically to the field of janitorial cleaning carts having wheels for collecting trash and laundry and for storing cleaning supplies.

### BACKGROUND OF THE INVENTION

For the majority of Americans, household chores are a basic fact of daily life. Whether pushing a vacuum cleaner to remove dirt from carpet, swirling a feather duster over tabletops and along shelves to absorb dust accumulation or meticulously wiping windows and mirrors to a pristine shine, a home that is spotlessly clean is a goal that consumers strive for whenever possible. The same is true for commercial establishments whether office buildings, hotels, schools, or hospitals. With large amounts of traffic going through these establishments every day, most of them have to employ a full time janitorial staff to maintain cleanliness in each and every corner of the building.

To better accomplish large area maintenance, particularly when collecting garbage for disposal or linens for laundering, janitorial personnel typically access and push a wheeled cart. As convenient as the standard collection cart may be, there are some drawbacks to its use. Particularly, these carts are usually quite small and cannot house a large amount in one sweep. Commercial workers find themselves continuously emptying the cart before being able to round up more of the many garbage bags and soiled linens that accumulate in just one day. Current carts are usually set up with cheaply made wheels that invariably squeak under their burdens, creating a cacophony of unpleasant noises that are disturbing in settings that need to be shrouded in quiet.

The prior art has put forth several designs for rolling carts for collecting trash and laundry and storing cleaning supplies. Among these are:

US Patent 2010/0072718 to Raelene Jo Funk describes a compactable utility laundry pushcart, with a weight activated rising and lowering bottom. The pushcart has built in storage compartments for laundry detergents, hangars and accessories as well as change money, keys and cup holders. The pushcart is durably constructed with an approximately three to five year lifespan. The pushcart is functional for indoor use, and very effective for outdoor use in hauling and transferring of personal laundry and laundry accessories.

U.S. Pat. No. 7,455,246 to Blake H. Roth describes a wheeled handcart that has a rechargeable, battery powered, low pressure pump and spray apparatus for applying chemical cleaning solutions to sanitize commercial restroom facilitates. The handcart also contains functionality for filling hand applicators with diluted chemical solutions.

U.S. Pat. D320,683 to Robert J. Welch describes an ornamental design for a wheeled linen carts containing numerous enclosed spaces for storing linen and cleaning supplies.

None of these prior art references describe the present invention.

### SUMMARY OF THE INVENTION

It is an object of the present invention to provide an enlarged rolling cart that maximizes garbage and linen collection in commercial applications and is equipped with virtually soundless wheels.

The present invention is a janitorial cleaning cart for maximizing garbage and linen collection. The janitorial cleaning cart comprises a cart having a bottom wall, a front wall, a rear wall opposite the front wall, a first side wall between the front wall and the rear wall, and a second side wall opposite the first side wall. The front wall, the rear wall, the first side wall, and the second side wall are connected to and extend in a generally upward direction from the bottom wall. A top opening is formed opposite the bottom wall. An outer perimeter rim surrounds the top opening. A cover lid is restable on the outer perimeter rim for selectively closing the top opening. A front opening is formed in the front wall of the cart. At least one door selectively closes the front opening. A plurality of wheels is mounted to the bottom wall. The cart provides an efficient and user friendly means of trash and linen collection.

In addition, the present invention includes a method for maximizing garbage and linen collection. The method comprises providing a cart having a bottom wall, a front wall, a rear wall opposite the front wall, a first side wall between the front wall and the rear wall, and a second side wall opposite the first side wall, the front wall, connecting the rear wall, the first side wall, and the second side wall to and extending in a generally upward direction from the bottom wall, forming a top opening opposite the bottom wall, surrounding the top opening with an outer perimeter rim, resting a cover lid on the outer perimeter rim, selectively closing the top opening with the cover lid, forming a front opening in the front wall of the cart, selectively closing the front opening, mounting a plurality of wheels to the bottom wall, and providing an efficient and user friendly means of trash and linen collection.

The present invention further includes a janitorial cleaning cart for maximizing garbage and linen collection. The janitorial cleaning cart comprises a cart having a bottom wall, a front wall, a rear wall opposite the front wall, a first side wall between the front wall and the rear wall, and a second side wall opposite the first side wall. The front wall, the rear wall, the first side wall, and the second side wall are connected to and extend in a generally upward direction from the bottom wall. A top opening is formed opposite the bottom wall with an outer perimeter rim surrounding the top opening. A cover lid rests on the outer perimeter rim and completely covers the top opening with the cover lid receiving the outer perimeter rim within and under the cover lid. A front opening is formed in the front wall of the cart and a pair of doors for selectively close the front opening. A fluid tight debris cleanout door is mounted in the bottom wall of the cart and a pair of wheels mounted to the bottom wall at each corner of the cart. The cart provides an efficient and user friendly means of trash and linen collection.

### BRIEF DESCRIPTION OF THE DRAWINGS

FIG. 1 is a front perspective view illustrating a janitorial cleaning cart, constructed in accordance with the present invention showing, a lid, a side handle, front side doors, and double rolling wheels with releasable locking mechanisms.

FIG. 2 is a rear perspective view illustrating the janitorial cleaning cart, constructed in accordance with the present invention, showing the lid, the side handle, a solid curved rear side without doors, and the double rolling wheels with releasable locking mechanisms.

FIG. 3 is another front perspective view illustrating the janitorial cleaning cart, constructed in accordance with the present invention, showing the lid in an open position, the side doors in an open position, and the double rolling wheels with releasable locking mechanisms.

FIG. 4 is a perspective view illustrating the janitorial cleaning cart, constructed in accordance with the present invention, with the side doors in the open position to show a large amount of interior space for holding linens and a small debris cleanout door.

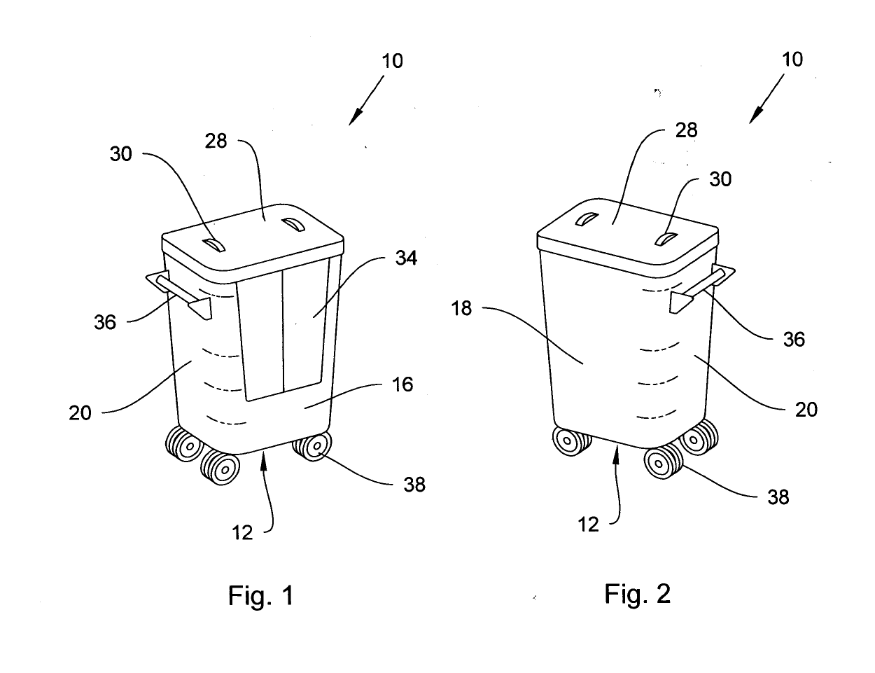

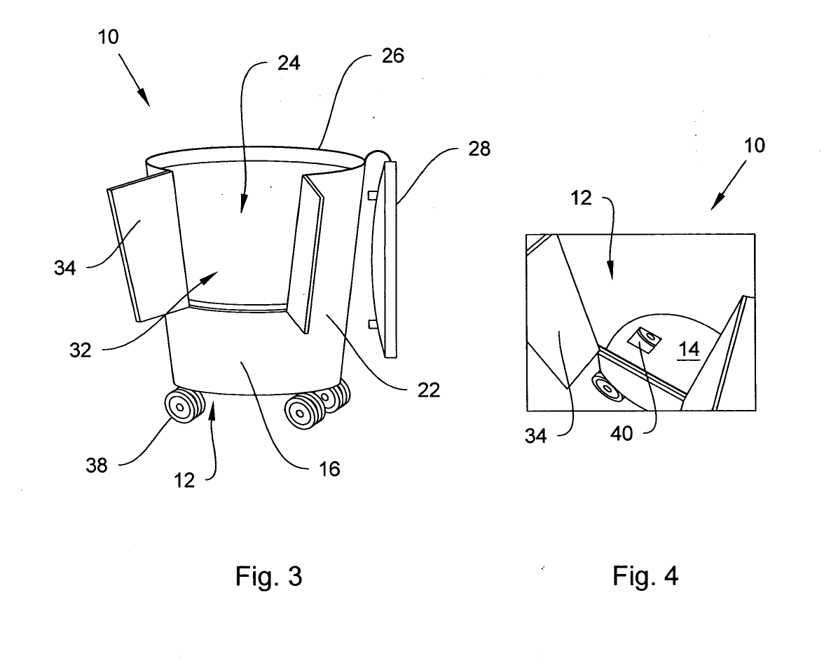

### DETAILED DESCRIPTION OF THE INVENTION

The present invention, hereinafter referred to as a Janitorial Cleaning Cart, indicated generally at 10, is a multifunctional wheeled cart 12 built to maximize garbage and linen collection in commercial applications. The Janitorial Cleaning Cart 10 is configured to provide professional cleaners with an optimally convenient means of performing their jobs while also conforming to the quiet atmosphere needed for facilities such as hospitals, nursing homes, hotels, and schools.

Constructed for linen and garbage collection, the Janitorial Cleaning Cart 10 of the present invention is an enlarged collection cart 12 having a bottom wall 14, a front wall 16, a rear wall 18 opposite the front wall 16, a first side wall 20 between the front wall 16 and the rear wall 18, and a second side wall 22 opposite the first side wall 20. Preferably, the front wall 16, the rear wall 18, the first side wall 20, and the second side wall 22 are connected to and extend in a generally upward direction from the bottom wall 14. At the other end of the front wall 16, the rear wall 18, the first side wall 20, and the second side wall 22, opposite the bottom wall 14, is a top opening 24 for receiving garbage and linen into the cart 12 with the top opening 24 surrounded by and defined by an outer perimeter rim 26.

The Janitorial Cleaning Cart 10 of the present invention further includes a cover lid 28 hingedly secured to either the outer perimeter rim 26, the front wall 16, the rear wall 18, the first side wall 20, or the second side wall 22 for covering at least a portion of the top opening 24. The hinged cover lid 28 allows the top opening 24 to be completely covered by encompassing and receiving the outer perimeter rim 26 within and under the cover lid 28. It should be noted that while the cover lid 28 has been described as completely covering the top opening 24, it is within the scope of the present invention for the cover lid 28 to only partially cover the top opening 24. A lid handle 30 can be mounted to the cover lid 28 to assist the user in opening the cover lid 28 into the open position and/or closing the cover lid 28 into the closed position over the top opening 24.

In a preferred embodiment, the cover lid 28 of the Janitorial Cleaning Cart 10 of the present invention is hingedly secured to the second side wall 22 adjacent the outer perimeter rim 26 and completely covers the top opening 24 when in the closed position. The cover lid acts 28 as a rain deflecting shield preferably measuring approximately forty three and three quarter (43¾″) inches in diameter although having a cover lid 28 with different dimensions is within the scope of the present invention.

In addition, in an embodiment of the Janitorial Cleaning Cart 10 of the present invention, the front wall 16 of the cart has a front opening 32 formed therein for creating an open space for item placement while transferring items into the cart 23 and to help transfer items into the cart 12 in an effortless manner. Preferably, the front opening 32 extends through the outer perimeter rim 26 to a point short of the bottom wall 14, although extending the front opening 32 the entire way to the bottom wall 14 is within the scope of the present invention.

Additionally, the Janitorial Cleaning Cart 10 of the present invention includes at least one door 34 hingedly connected to the front wall 16 of the cart 12 to open and close the front opening 32. In a preferred embodiment, the cart 12 includes a pair of doors 34 hingedly secured to the front wall 16 of the cart 12 and independently moveable relative to each other to open and close the front opening 32. In an embodiment, a single door is provided having a hinged opening on one side of the door, and a latch on side of the door opposite the side having the hinge. A mechanical latch or other mechanism can releasably secure the doors 34 in the closed position. Or, in an embodiment, the doors 34 can be held in the closed position by the cover lid 28 being closed and encompassing the outer perimeter rim 26, as described above, and thus, at least a portion of the doors 34.

The Janitorial Cleaning Cart 10 of the present invention additionally includes a side handle 36 mounted to the first side wall 20 of the cart 12. The first side handle 36 allows the user to easily manipulate and maneuver the cart 12 to a desired location.

Furthermore, the Janitorial Cleaning Cart 10 of the present invention is equipped with soundless, noise reduction wheels 38 mounted to the bottom wall 14 of the cart 12. Preferably, the cart 12 includes a pair of wheels 38 at each corner of the cart 12 for a total of eight (8) wheels 38 although providing a cart 12 having more wheels 38 or less wheels 38 is within the scope of the present invention. Unique to the Janitorial Cleaning Cart 10 of the present invention is that not only does the cart provide a large capacity cart for efficient storage and virtually eliminates the noise common to standard carts due to the specially constructed wheels 38.

As described, the cart 12 of the Janitorial Cleaning Cart 10 of the present invention sits upon the four sets of double casted wheels 38 configured for silent operation. The quiet functioning of the wheels 38 is accomplished by means of a muffling implement or a component that self-lubricates to prevent the wheels 38 from squeaking. In a preferred embodiment, the wheels 38 contain locking mechanisms to keep the cart 12 in place while loading providing a valuable safety feature for its users.

The Janitorial Cleaning Cart 10 of the present invention further includes a small debris cleanout door 40 located in and hingedly connected to the bottom wall 14 of the cart 12 allowing any solids or fluids to be removed or drain out when open. The cleanout door 40 is preferably fluid tight when in a closed position and can be opened and closed, as desired or needed. A mechanical latching mechanism can be provided to assist in holding the cleanout door 40 in a closed manner.

In addition to the large amount of space for holding linens, the depth of the Janitorial Cleaning Cart 10 of the present invention is sufficient to store up to approximately sixteen garbage bags at once. Preferably, the cart 12 of the Janitorial Cleaning Cart 10 is constructed from a combination of durable plastic and metal materials and configured in a substantially square shape or a substantially round shape. Preferred dimensions of the cart 12 of the Janitorial Cleaning Cart 10 are approximately fifty nine (59″) inches in height and forty six and seven eighths (46⅞″) inches in interior depth. It should be noted that while the cart 12 has been described as having particular dimensions, it is within the scope of the present invention for the cart to have greater or lesser dimensions than the dimensions set forth herein.

The Janitorial Cleaning Cart 10 of the present invention provides janitorial and professional cleaning staff with a more efficient and user friendly means of trash and linen collection. Configured with a much roomier interior section, busy cleaners no longer waste valuable time making repeated trips back and forth to empty and refill the bin. The cover lid 28 of the cart 12 ensures that collected items are protected from rain and any other external factors that may compromise the contents. The front opening 32 formed in the front wall 16 of the cart 12 enables heavy linens and trash bags to be inserted and removed without undue strain on the user. The incorporation of noiseless wheels 38 respectfully reduces noise levels in hospitals and nursing homes where patients need quiet for healing rest, rolls soundlessly down school halls as to not disturb the educational process, and navigates undetected through hotel corridors when guests are sleeping. Increasing productivity, the Janitorial Cleaning Cart 10 has many benefits that will be appreciated by the facilities that employ full time cleaning personnel, as it helps save both time and money. As such, the Janitorial Cleaning Cart 10 will be well received by all janitorial staffs, as well as the venues which employ them, a very sizable market potential. Constructed with durable, high quality materials and components, the Janitorial Cleaning Cart 10 will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A janitorial cleaning cart for maximizing garbage and linen collection, the janitorial cleaning cart comprising:
a cart having a bottom wall, a front wall, a rear wall opposite the front wall, a first side wall between the front wall and the rear wall, and a second side wall opposite the first side wall, the front wall, the rear wall, the first side wall, and the second side wall are connected to and extend in a generally upward direction from the bottom wall;
a top opening opposite the bottom wall;
an outer perimeter rim surrounding the top opening;
a cover lid restable on the outer perimeter rim for selectively closing the top opening;
a front opening formed in the front wall of the cart;
at least one door for selectively closing the front opening; and
a plurality of wheels mounted to the bottom wall;
wherein the cart provides an efficient and user friendly means of trash and linen collection.

2. The janitorial cleaning cart of claim 1 wherein the cover lid is hingedly secured to the second side wall adjacent the outer perimeter rim.

3. The janitorial cleaning cart of claim 1 wherein the cover lid completely covers the top opening.

4. The janitorial cleaning cart of claim 1 wherein the cover lid receives the outer perimeter rim within and under the cover lid.

5. The janitorial cleaning cart of claim 1 and further comprising:
a lid handle mounted to the cover lid.

6. The janitorial cleaning cart of claim 1 wherein the front opening extends through the outer perimeter rim to a point short of the bottom wall.

7. The janitorial cleaning cart of claim 1 and further comprising:
a pair of doors hingedly secured to the front wall of the cart and independently moveable relative to each other to open and close the front opening.

8. The janitorial cleaning cart of claim 7 wherein the doors are held in a closed position by the cover lid being closed and encompassing the outer perimeter rim.

9. The janitorial cleaning cart of claim 1 wherein the wheels are soundless, noise reduction wheels mounted to the bottom wall of the cart.

10. The janitorial cleaning cart of claim 9 and further comprising:
a pair of wheels at each corner of the cart; and
a muffling implement or self-lubricating mechanism applied to the wheels.

11. The janitorial cleaning cart of claim 9 and further comprising:
a locking mechanism associated with the wheels.

12. The janitorial cleaning cart of claim 1 and further comprising:
a debris cleanout door located in and hingedly connected to the bottom wall of the cart.

13. The janitorial cleaning cart of claim 12 wherein the debris cleanout door is fluid tight when in a closed position.

14. The janitorial cleaning cart of claim 1 and further comprising:
a first side handle mounted to the first side wall.

15. A method for maximizing garbage and linen collection, the method comprising:
providing a cart having a bottom wall, a front wall, a rear wall opposite the front wall, a first side wall between the front wall and the rear wall, and a second side wall opposite the first side wall;
connecting the front wall, the rear wall, the first side wall, and the second side wall are connected to the bottom wall;
extending the front wall, the rear wall, the first side wall, and the second side wall in a generally upward direction from the bottom wall;
forming a top opening opposite the bottom wall;
surrounding the top opening with an outer perimeter rim;
resting a cover lid on the outer perimeter rim;
selectively closing the top opening with the cover lid;
forming a front opening in the front wall of the cart;
selectively closing the front opening;
mounting a plurality of wheels to the bottom wall; and
providing an efficient and user friendly means of trash and linen collection.

16. A janitorial cleaning cart for maximizing garbage and linen collection, the janitorial cleaning cart comprising:
a cart having a bottom wall, a front wall, a rear wall opposite the front wall, a first side wall between the front wall and the rear wall, and a second side wall opposite the first side wall, the front wall, the rear wall, the first side wall, and the second side wall are connected to and extend in a generally upward direction from the bottom wall;
a top opening opposite the bottom wall;
an outer perimeter rim surrounding the top opening;
a cover lid restable on the outer perimeter rim and completely covering the top opening, the cover lid receiving the outer perimeter rim within and under the cover lid;
a front opening formed in the front wall of the cart;
a pair of doors for selectively closing the front opening;
a fluid tight debris cleanout door in the bottom wall of the cart; and
a pair of wheels mounted to the bottom wall at each corner of the cart;
wherein the cart provides an efficient and user friendly means of trash and linen collection.

17. The janitorial cleaning cart of claim 16 and further comprising:
a lid handle mounted to the cover lid.

18. The janitorial cleaning cart of claim 16 wherein the front opening extends through the outer perimeter rim to a point short of the bottom wall.

19. The janitorial cleaning cart of claim 16 wherein the pair of doors are independently moveable relative to each other to open and close the front opening and are held in a closed position by the cover lid being closed and encompassing the outer perimeter rim.

20. The janitorial cleaning cart of claim 16 and further comprising:
a muffling implement or self-lubricating mechanism applied to the wheels.
